(19) United States
(12) Patent Application Publication
(10) Pub. No.: US 2012/0048884 A1
(43) Pub. Date: Mar. 1, 2012

(54) APPARATUS AND METHOD FOR DISPENSING A LIQUID

(76) Inventors: Zhenfeng Wang, Singapore (SG); Huan Ming Xia, Singapore (SG)

(21) Appl. No.: 13/266,448

(22) PCT Filed: Apr. 27, 2009
(86) PCT No.: PCT/SG2009/000153

§ 371 Date: Oct. 26, 2011

(51) Int. Cl. B67D 7/60

(52) U.S. Cl. 222/1; 222/401

(57) ABSTRACT

An apparatus for dispensing a liquid, the apparatus comprising a chamber for containing the liquid and a gas therein; an outlet in fluid connection with the chamber for releasing the liquid from the apparatus; a pressure-sensitive barrier in the fluid connection between the outlet and the chamber for preventing release of the liquid from the chamber and for allowing passage of the liquid therethrough only when there is at least a critical pressure difference between pressure of the gas in the chamber and atmospheric pressure; and a compressing element for compressing the gas to a raised pressure upon a one-time activation of the compressing element, wherein difference between the raised pressure and atmospheric pressure is at least the same as the critical pressure difference.

### FIELD OF THE INVENTION

The invention relates to an apparatus and method for dispensing a liquid and particularly, though not exclusively, relates to a disposable apparatus for use with lab-on-a-chip devices.

### BACKGROUND

In applications using a lab-on-a-chip device, doses of liquids are typically loaded into a microfluidic system in the device via an opening into a reservoir in the device. Loading a liquid dose may be performed manually using a pipette or a syringe, or it may be performed by some way of powered mechanized pumping such as using as syringe pump, peristaltic pump, piezoelectric pump or charge-induced pump, wherein pumping volume and speed can be controlled by adjusting pumping power and injection time.

Manual loading of liquid doses via pipette or syringe requires a user to be skilled or trained in order to achieve good, repeatable control of liquid loading volume or speed, so as to ensure proper functioning of the device. This is especially important where multiple tests are needed using multiple devices, since consistent testing conditions should be maintained in order to obtain reliable results.

With low-cost lab-on-a-chip devices being particularly suitable for disposable point-of-care applications, requiring manual loading of a liquid dose by a skilled user is undesirable because point-of-care applications typically involve only the patient or their caregivers, and such persons would not usually be sufficiently skilled or trained to perform the manual liquid loading with the necessary consistency and control. Similar problems are faced where the lab-on-a-chip-device is a portable device for field use such as in liquid sample collection and testing, wherein the user may be a field operator unskilled in laboratory microfluidic techniques and for whom manual loading of the sample would be difficult.

Replacing manual liquid loading with powered mechanized pumping in such point-of-care or field applications requires power consumption and associated pump components to be provided, adding to bulk and cost of the device. In addition, a significant portion of power will be required to drive the pump compared to power required for other functional modules such as signal detection or processing. This can present a critical issue for battery-powered portable devices.

### SUMMARY OF THE INVENTION

According to a first exemplary aspect, there is provided an apparatus for dispensing a liquid. The apparatus comprises a chamber for containing the liquid and a gas therein; an outlet in fluid connection with the chamber for releasing the liquid from the apparatus; a pressure-sensitive barrier in the fluid connection between the outlet and the chamber for preventing release of the liquid from the chamber and for allowing passage of the liquid therethrough only when there is at least a critical pressure difference between pressure of the gas in the chamber and atmospheric pressure; and a compressing element for compressing the gas to a raised pressure upon a one-time activation of the compressing element, wherein difference between the raised pressure and atmospheric pressure is at least the same as the critical pressure difference.

Volume of the chamber is preferably kept constant after the one-time activation of the compressing element by configuring the compressing element to be lockable relative to the chamber.

The pressure-sensitive barrier may comprise a membrane having a plurality of perforations therethrough. The critical pressure difference is preferably dependent on a pressure sensitivity of the pressure-sensitive barrier.

The outlet is preferably configured for establishing fluid connection with a lab-on-a-chip device.

According to a second exemplary aspect, there is provided a method of dispensing a liquid from an apparatus for dispensing the liquid, the apparatus comprising a chamber containing a liquid and a gas therein and an outlet in fluid connection with the chamber. The method comprises compressing the gas in the chamber to a raised pressure such that difference between the raised pressure and atmospheric pressure is at least the same as a critical pressure difference for allowing passage of the liquid through a pressure-sensitive barrier in the fluid connection between the chamber and the outlet.

The method further may comprise maintaining a constant volume of the chamber after compressing the gas in the chamber. Compressing the gas may comprise a one-time activation of a compressing element in engagement with the chamber. Maintaining a constant volume of the chamber may comprise locking the compressing element relative to the chamber.

For all aspects, the compressing element may comprise a plunger slideably engageable with the chamber such that the one-time activation or compressing the gas may comprise depressing the plunger into the chamber. Alternatively, the compressing element may comprise a plunger rotatably engageable with the chamber such that the one-time activation or compressing the gas may comprise rotating the plunger into the chamber.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

In the drawings:

FIG. 1 (a) is a schematic cross-sectional side view of a first exemplary embodiment of an apparatus for dispensing liquid before activation;

FIG. 1 (b) is a schematic exploded perspective view of the apparatus of FIG. 1 (a);

FIG. 2 (a) is a schematic cross-sectional side view of the apparatus of FIG. 1 (a) in fluid connection with a lab-on-a-chip device after activation;

FIG. 2 (b) is a schematic perspective view of the apparatus of FIG. 2 (a);

FIG. 3 is a schematic plan view of a first exemplary embodiment of a membrane of the apparatus of FIG. 1 (a);

FIG. 4 (a) is a schematic exploded perspective view of a second exemplary embodiment of an apparatus for dispensing liquid;

FIG. 4 (b) is a schematic cross-sectional side view of the apparatus of FIG. 4 (a) before activation;

FIG. 4 (c) is a schematic cross-sectional side view of the apparatus of FIG. 4 (a) when activated;

FIG. 5 (a) is a schematic cross-sectional side view of a second exemplary embodiment of a membrane of the apparatus of FIG. 1 (a);

FIG. 5 (b) is a schematic plan view of the membrane of FIG. 5 (a) before activation;

FIG. 5 (c) is a schematic plan view of the membrane of FIG. 5 (a) after activation; and

FIG. 6 is a graph of dispensing rate and liquid volume and gas pressure with time.

### DETAILED DESCRIPTION OF THE EXEMPLARY EMBODIMENTS

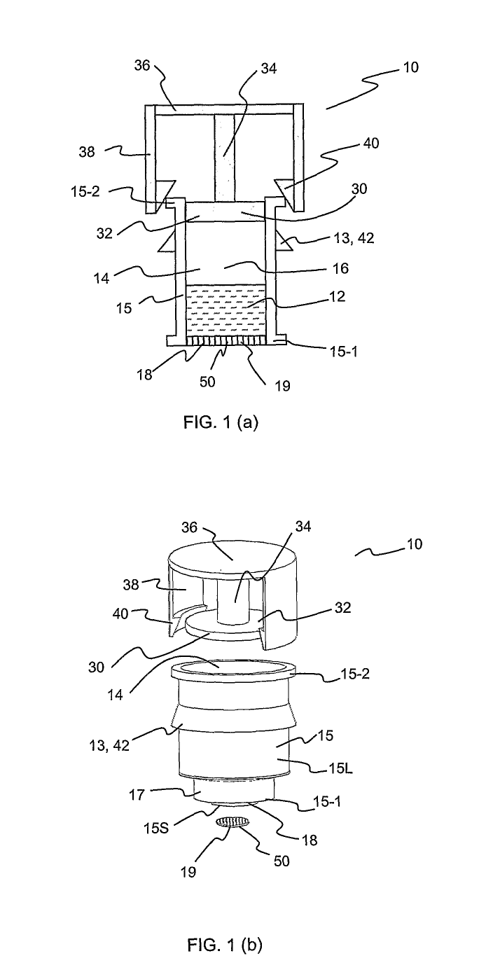

A first exemplary embodiment of an apparatus 10 for dispensing liquid is shown in FIGS. 1 (a) to 3. The apparatus 10 may be a disposable cartridge for use with a lab-on-a-chip device 20 having a microfluidic system 22. In use, prior to activation, the apparatus 10 is pre-loaded with a fixed amount of a liquid 12 that is to be dispensed from the apparatus 10 when the liquid 12 is to be loaded into the microfluidic system 22. The liquid 12 may be a reagent for use in a particular diagnostic test that the lab-on-a-chip device 20 is designed for. The apparatus 10 is also pre-loaded with a fixed amount of a gas 16.

The apparatus 10 comprises a chamber 14 for containing the liquid 12 together with the gas 16 therein. The gas 16 may be air or an inert gas. Prior to activation of the apparatus 10, the gas 16 is preferably at atmospheric pressure. The apparatus 10 also comprises an outlet 18 in fluid connection with the chamber 14. The outlet 18 is for releasing the liquid 12 from the apparatus 10. In the fluid connection between the outlet 18 and the chamber 14, a pressure-sensitive barrier 19 is provided. The pressure-sensitive barrier 19 is configured for preventing release of the liquid 12 from the chamber 14 when the gas 16 is at atmospheric pressure.

In the first preferred embodiment, the chamber 14 is defined by a generally cylindrical barrel 15 made of a plastics such as FEP (Fluorinated Ethylene Propylene) or PP (Polypropylene), the pressure-sensitive barrier 19 at a first end 15-1 of the cylindrical barrel 15 at the outlet 18, and a compressing element 30 slideably engageable with the chamber 14 from a second end 15-2 of the cylindrical barrel 15 opposite the first end 15-1. The cylindrical barrel 15 may comprise a larger portion 15L having an inner diameter of 30 mm and a height of 30 mm, and a smaller portion 15S having an inner diameter of 10 mm and a height of 8 mm.

The compressing element 30 is a plunger 30 comprising a compression disc 32, a stalk 34 and an activating disc 36 having flanges 38. The compression disc 32 is configured to slideably engage the cylindrical barrel 15 interiorly and to form a seal with the cylindrical barrel 15. Preferably, the compression disc 32 engages the larger portion 15L of the cylindrical barrel 15. A first end of the stalk 34 is perpendicularly attached to the centre of the compression disc 32 while a second end of the stalk 34 is perpendicularly attached to the centre of the activating disc 36. The activating disc 36 is thus connected to the compression disc 32 via the stalk. The flanges 38 on the activating disc 36 project perpendicularly from the activating disc 36 in the direction of the compression disc 32. The compression disc 32, the stalk 34, the activating disc 36 and the flanges 38 are preferably integral with one another, and made of an injection-moulded plastics.

The activating disc 36 and compression disc 32 are relatively sized such that when the plunger 30 is assembled with the cylindrical barrel 15, the compressing disc 32 fits into the cylindrical barrel 15 from the second end 15-2. The flanges 38 are positioned to be ready to engage a circular rim 13 arranged around the cylindrical barrel 15 when the apparatus 10 is activated. The flanges 38 and the rim 13 are configured to engage each other via corresponding snap-fit configurations 40, 42 provided on the flanges 38 and the rim 13 respectively. The corresponding snap-fit configurations 40, 42 preferably comprise cantilever hooks 40 formed on the flanges 38 and a ringed recess 42 provided by the rim 13.

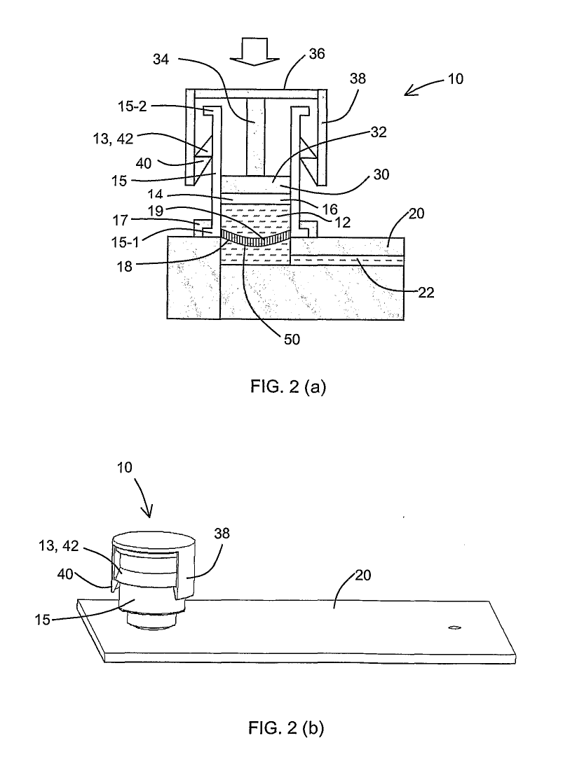

As shown in FIG. 2 (a), the apparatus 10 is activated by a user pushing on the activating disc 36 in the direction of the arrow and thereby depressing the plunger 30 into the chamber 14 until the snap-fit configurations 40, 42 engage each other to lock the compressing element 30 relative to the chamber 14. As the compression disc 32 is pushed into the cylindrical barrel 15, volume of the chamber 14 decreases as the flanges 38 are elastically deflected outwardly by the rim 13 and slide over the rim 13 until a final reduced volume is reached when the cantilever hooks 40 on the flanges 38 clear the rim 13 and engage the ringed recess 42 provided by the rim 13, i.e., the. snap-fit configurations 40, 42 engage each other or “click” together. Activation of the apparatus 10 is therefore designed to be a one-time activation of the compressing element 30 to reduce the volume of the chamber 14 with a single “click”. When engaged, the snap-fit configurations 40, 42 prevent the compressing element 30 from moving in the direction opposite from that shown by the arrow. In this way, the compressing element 30 is configured to be lockable relative to the chamber 14.

In use, prior to activation of the apparatus 10 (i.e. in a storage state), the apparatus 10 is first connected to the lab-on-a-chip device 20 such that the outlet 18 forms a fluid connection with the microfluidic system 22 in the lab-on-a-chip device 20. A Luer-lock connection 17 may be provided at the outlet 18 for fitting with a corresponding Luer-lock connection 17 on the lab-on-a-chip device 20. Upon a one-time activation of the compressing element 30, the chamber 14 reaches its final reduced volume with a single click. Because the volume of the chamber 14 is reduced after activation, the fixed amount of liquid 12 and the fixed amount of gas 16 that have been pre-loaded in the chamber 14 are now contained in a smaller chamber volume after activation. Since the liquid 12 cannot be significantly compressed, reduction in volume of the chamber 14 therefore causes reduction in volume of the fixed amount of gas 16 in the chamber 14. Activation therefore compresses the gas 16 in the chamber 14 to a raised pressure when compared to the pressure of the gas 16 prior to activation.

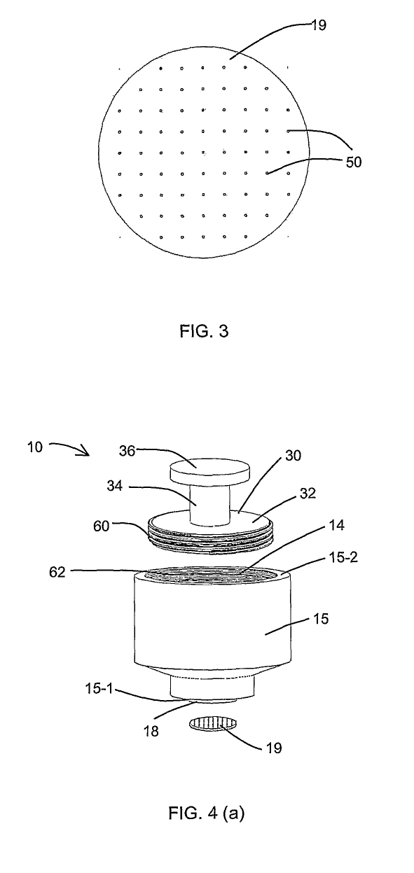

In the first embodiment, the pressure-sensitive barrier 19 is preferably a membrane 19 comprising an elastomeric sheet having a plurality of perforations 50 therethrough as shown in FIG. 3. The membrane 19 may be of silicon rubber and have a thickness of 400 μm and diameter of 30 mm. The perforations 50 may be a regular array of 69 micrometer-sized holes 50 with a diameter of 5 μm each and spaced apart by 1 mm. Preferably, at least a surface of the membrane is hydrophobic. The membrane 19 may have a Young's Modulus ranging from 500 kPa to 20 MPa, more preferably 3 MPa, and a Poisson's ratio of 0.5.

When the gas 16 in the chamber 14 is at atmospheric pressure, the liquid 12 does not leave the chamber 14 through the perforations 50 in the membrane 19 due to surface tension at the liquid-air interface of the perforations 50. However, when the pressure of the gas 16 in the chamber is raised to be greater than atmospheric pressure, the pressure difference between pressure of the gas 16 and atmospheric pressure causes a force to be exerted on the membrane 19. The force exerted on the membrane causes the membrane to undergo elastic deformation, i.e., the membrane is stretched outwardly with respect to the chamber 14 as shown in FIG. 2 (a). As the membrane 19 is stretched, the perforations 50 correspondingly enlarge. When there is at least a critical pressure difference pressure between pressure of the gas 16 and atmospheric pressure, the membrane 19 is sufficiently stretched and the perforations 50 become sufficiently enlarged so that the surface tension is overcome and the liquid 12 leaves the chamber 14 through the perforations 50 under the raised pressure of the gas 16. The critical pressure difference therefore depends on the pressure sensitivity of the pressure-sensitive barrier 19.

After activation of the apparatus 10, the volume of the chamber 14 is kept constant at the final reduced volume by locking the compressing element 30 relative to the chamber 14. Consequently, as the liquid 12 is dispensed from the chamber 14, ratio of the amount of gas 16 to the amount of liquid 12 in the chamber 14 increases. As the fixed amount of gas 16 in the chamber expands to take up the space in the chamber 14 left by the dispensed liquid 12, the pressure of the gas 16 consequently decreases as the gas 16 decompresses.

So long as the difference between the pressure of the gas 16 and atmospheric pressure is greater than the critical pressure difference required for the perforations 50 to allow passage of the liquid 12 therethrough, the liquid 12 will continue to be dispensed from the chamber 14. Depending on the amount of liquid 12 pre-loaded in the chamber 14, all or some of the liquid 12 may be dispensed from the chamber 14 after activation. Although the gas 16 tends to equilibrate back towards atmospheric pressure while the liquid 12 is being dispensed, it is preferred that the pressure of the gas 16 remains at around 80% of the raised pressure of the gas 16 when dispensation of the liquid 12 is completed.

The critical pressure difference required to allow liquid 12 through the perforations 50 of a specific membrane 19 can be pre-determined depending on the characteristics of the membrane 19 and the perforations 50. Similarly, by appropriately configuring the volume of the chamber 14 and the amount of liquid 12 and gas 16 pre-loaded in the chamber 14 prior to activation of the apparatus 10, the raised pressure of the gas 16 after activation can also be pre-determined to establish a desired period of time wherein the difference between pressure of the gas 16 and atmospheric pressure is greater than the critical pressure. In this way, the apparatus 10 can be appropriately configured to ensure that after activation, a pre-determined amount of the liquid 12 is eventually dispensed from the apparatus 10.

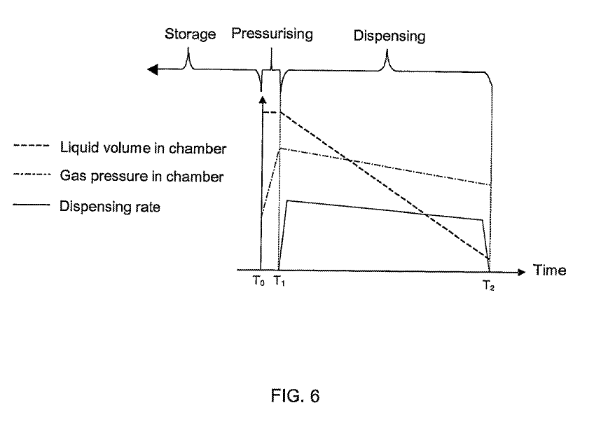

FIG. 6 shows curves of volume of the liquid 12 in the chamber 14, pressure of the gas 16 in the chamber and dispensing rate Q of the liquid 12 over time as the apparatus 10 is used.

The dispensing rate Q may be calculated using Hagen-Poiseuille equation as:

$$Q = \frac{π {r}^{4}}{8 μ L} Δ P \cdot n$$

where ΔP is the difference between pressure in the liquid 12 on either side of the membrane 19, r is the radius of the micro holes 50; L is the thickness of the membrane 19, μ is the dynamic viscosity of the fluid and n is the number of microholes 50 in the membrane 19.

Time T₀ marks the start of activating the compressing element 30 until it is locked relative to the chamber 14 at Time T₁. Before time T₀, the apparatus 10 is in a storage state with a certain volume of the liquid 12 pre-loaded in the chamber 14 and with the gas 16 at atmospheric pressure. In a pressurising state between T₀ and T₁, pressure of the gas 16 in the chamber 14 increases from atmospheric pressure at T₀ to a maximum raised pressure at T₁ as the plunger 30 is pushed into the chamber 14. As the time interval between T₀ and T₁ is short, this interval being the time taken for the one-time activation of the compressing element 30, it is assumed that the liquid 12 is not dispensed until time T₁ where the apparatus 10 is fully activated. In the dispensing state between T₁ and T₂, as the liquid 12 is dispensed from the chamber 14, volume of the liquid 12 in the chamber 14 decreases. Pressure of the gas 16 correspondingly decreases, as described above. The dispensing rate Q of the liquid 12 from the apparatus 10 is thus a function of the difference in pressure of the liquid 12 on either side of the membrane 19. Everything else being equal, the dispensing rate Q becomes directly proportional to the difference in pressure, as shown by the equation. The dispensing rate Q decreases gradually from an initial maximum shortly after time T₁ and drops sharply close to when dispensing is complete at time T₂.

As shown in FIG. 6, smooth and continuous dispensing of the liquid 12 from the apparatus 10 is obtained with a simple one-time activation of the compressing element 30.

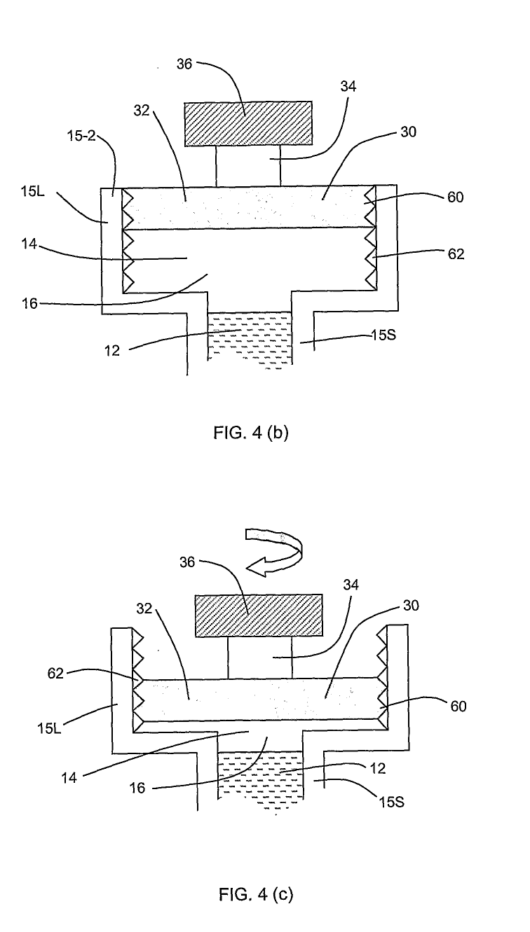

A second exemplary embodiment of the apparatus 10 is shown in FIGS. 4 (a) to (c). Similar reference numerals have been retained for similar parts. In the second embodiment, the chamber 14 for containing the liquid 12 and the gas 16 therein is also defined by a generally cylindrical barrel 15 made of a plastics such as FEP or PP, a pressure-sensitive barrier 19 at a first end 15-1 of the cylindrical barrel 15 at the outlet 18, and a compressing element 30 engageable with the chamber 14 from a second end 15-2 of the cylindrical barrel 15 opposite the first end 15-1. The cylindrical barrel 15 may comprise a larger portion 15L having an inner diameter of 30 mm and a height of 30 mm, and a smaller portion 15S having an inner diameter of 10 mm and a height of 8 mm.

In the second embodiment, the compressing element 30 is also a plunger 30 comprising a compression disc 32 attached to an activating disc 36 via a stalk 34. However, instead of the plunger 30 slideably engaging the chamber 14 as shown in the first embodiment, in the second embodiment, the plunger 30 is rotatably engageable with the chamber 14 such that activation of the apparatus 10 is by turning the activation disc 36 as shown by the arrow in FIG. 4 (c).

Controlled rotation of the plunger 30 is achieved by means of the circumference of the compression disc 32 being threaded 60 for acting against a corresponding thread 62 in the interior of the cylindrical barrel 15. One-time activation of the apparatus 10 therefore means rotating or screwing the plunger 30 into the chamber 14 to reduce the volume of the chamber 14. By appropriately configuring the thread 62 in the cylindrical barrel 15 using known mechanical arrangements, the plunger 30 in the second embodiment can therefore be locked relative to the chamber 14 at the end of activation to maintain a constant reduced volume of the chamber 14 after activation. No flanges and no snap-fit configurations are required in the second embodiment.

The second embodiment thus differs from the first embodiment mainly in the way that the volume of the chamber 14 is reduced, i.e., by rotating the plunger 30 in the second embodiment as opposed to depressing the plunger 30 in the first embodiment. Dispensing of the liquid 12 occurs in the same way for both embodiments as a result of the gas 16 being compressed to a raised pressure upon a one-time activation of the compressing element 30 such that difference between pressure of the gas 16 and atmospheric pressure is greater than the critical pressure required for the pressure-sensitive barrier 19 to allow passage of the liquid 12 therethrough.

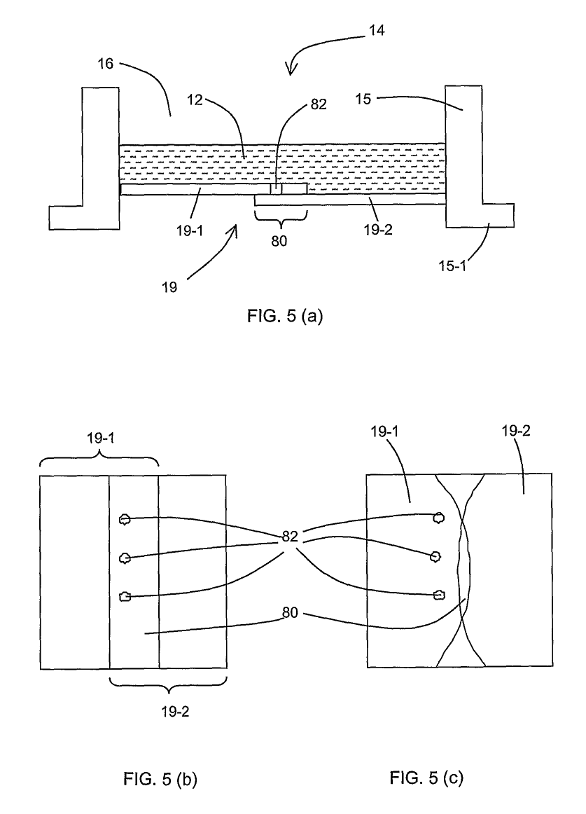

A second exemplary embodiment of the pressure-sensitive barrier 19 is shown in FIGS. 5 (a) to (c). Instead of a one-piece membrane 19 having holes 50 that enlarge upon stretching of the membrane 19, in the second embodiment, the pressure-sensitive barrier 19 comprises two flaps 19-1, 19-2 that partially overlap each other at an overlapping area 80 as shown in FIGS. 5 (a) and (b). Perforations 82 are provided through only one of the flaps 19-1 and only in the overlapping area 80. When the pressure of the gas 16 in the chamber is raised to be greater than atmospheric pressure, the pressure difference between pressure of the gas 16 and atmospheric pressure causes a force to be exerted on the flaps 19-1, 19-2. The force causes the flaps 19-1, 19-2 to flex outwardly with respect to the chamber 14 as shown in FIG. 5 (c). As the flaps 19-1, 19-2 flex outwardly, the area of overlap 80 decreases to uncover the perforations 82 in the perforated flap 19-1. By appropriately sizing and locating the perforations 82, the second embodiment of the pressure-sensitive barrier 19 may be configured for the perforations to be uncovered only when there is at least a critical pressure difference pressure between pressure of the gas 16 and atmospheric pressure, in order to allow the liquid 12 to leave the chamber 14 through the perforations 82.

The apparatus 10 in its various embodiments therefore eliminates the need for a user of the apparatus 10 and the lab-on-a-chip device 20 to be skilled or trained in loading a liquid dose into the lab-on-a-chip device 20. The apparatus 10 also does not require a bulky powered mechanized pumping system to be provided in order to achieve smooth and continuous liquid dispensing.

Whilst there has been described in the foregoing description exemplary embodiments of the present invention, it will be understood by those skilled in the technology concerned that many variations in details of design, construction and/or operation may be made without departing from the present invention. For example, the recess 42 for engaging the cantilever hook 42 on the flange 38 in the first embodiment may be provided by providing an appropriately located tab extending outwardly from the exterior of the cylindrical barrel 15 instead of providing the recess 42 via a circular rim 13 all around the barrel 15.

1. An apparatus for dispensing a liquid, the apparatus comprising:
a chamber for containing the liquid and a gas therein;
an outlet in fluid connection with the chamber for releasing the liquid from the apparatus;
a pressure-sensitive barrier in the fluid connection between the outlet and the chamber for preventing release of the liquid from the chamber and for allowing passage of the liquid therethrough only when there is at least acritical pressure difference between pressure of the gas in the chamber and atmospheric pressure; and
a compressing element for compressing the gas to a raised pressure upon a one-time activation of the compressing element, wherein difference between the raised pressure and atmospheric pressure is at least the same as the critical pressure difference.

2. The apparatus of claim 1, wherein volume of the chamber is kept constant after the one-time activation of the compressing element.

3. The apparatus of claim 2, wherein volume of the chamber is kept constant by configuring the compressing element to be lockable relative to the chamber.

4. The apparatus of claim 1, wherein the compressing element comprises a plunger slideably engageable with the chamber such that the one-time activation comprises depressing the plunger into the chamber.

5. The apparatus of claim 1, wherein the compressing element comprises a plunger rotatably engageable with the chamber such that the one-time activation comprises rotating the plunger into the chamber.

6. The apparatus of claim 1, wherein the pressure-sensitive barrier comprises a membrane having a plurality of perforations therethrough.

7. The apparatus of claim 1, wherein the outlet is configured for establishing fluid connection with a lab-on-a-chip device.

8. The apparatus of claim 1, wherein the critical pressure difference is dependent on a pressure sensitivity of the pressure-sensitive barrier.

9. A method of dispensing a liquid from an apparatus for dispensing the liquid, the apparatus comprising a chamber containing a liquid and a gas therein and an outlet in fluid connection with the chamber, the method comprising:
compressing the gas in the chamber to a raised pressure such that difference between the raised pressure and atmospheric pressure is at least the same as a critical pressure difference for allowing passage of the liquid through a pressure-sensitive barrier in the fluid connection between the chamber and the outlet.

10. The method of claim 9, further comprising maintaining a constant volume of the chamber after compressing the gas in the chamber.

11. The method of claim 9, wherein compressing the gas comprises a one-time activation of a compressing element in engagement with the chamber.

12. The method of claim 11, further comprising maintaining a constant volume of the chamber after compressing the gas in the chamber and wherein maintaining a constant volume of the chamber comprises locking the compressing element relative to the chamber.

13. The method of claim 11, wherein the compressing element comprises a plunger slideably engagable with the chamber such that compressing the gas comprises depressing the plunger into the chamber.

14. The method of claim 11, wherein the compressing element comprises a plunger rotatably engageable with the chamber such that compressing the gas comprises rotating the plunger into the chamber.
